(19) United States
(12) Patent Application Publication
(10) Pub. No.: US 2009/0273157 A1
(43) Pub. Date: Nov. 5, 2009

(54) SUB-TRAILER FOR A VEHICLE OR A TRAILER

(75) Inventors: Jeffrey Brian Scheuren, Escanaba, MI (US); Duane Lee Scheuren, Bark River, MI (US)

Correspondence Address: BROOKS KUSHMAN P.C., 1000 TOWN CENTER, TWENTY-SECOND FLOOR, SOUTHFIELD, MI, 48075, US

(73) Assignee: Jeffrey Brian Scheuren, Escanaba, MI (US)

(21) Appl. No.: 12/329,039

(22) Filed: Dec. 5, 2008

(51) Int. Cl. B62D 53/00

(52) U.S. Cl. 280/405.1

(57) ABSTRACT

A sub-trailer is provided having an attachment frame removably connected to a vehicle or trailer, an intermediate frame pivotally connected about a horizontal axis to the attachment frame to, and a subframe with two axles to support the subframe. The subframe is pivotally connected to the intermediate frame about another horizontal axis located between the first and second axles, and provides adequate load distribution from a load carried by the vehicle or trailer to the axles of the sub-trailer. Another sub-trailer is provided and is similar to the first sub-trailer, with the attachment frame removably and pivotally connected to the vehicle ro trailer about a vertical axis. Yet another sub-trailer is provided having a frame extending rearwards and being a vehicle, trailer, or attachment thereof; and a subframe pivotally connected to the frame about a horizontal axis, the subframe having two axles, each with a suspension system.

### BACKGROUND

1. Technical Field

Embodiments of the invention relate to a sub-trailer for attachment to a vehicle or a trailer, to distribute load therefrom.

2. Background Art

The prior art has provided various ways to transport and distribute a load to the ground using a vehicle or trailer. Additional load distribution is warranted when the vehicle or trailer cannot fully support the load it is required to carry. Efforts to better distribute a load began with a vehicle and then progressed to adding a trailer, and now include connecting an attachment to the vehicle or trailer such as an auxiliary axle or other assembly. One of the issues in using many of these systems occurs when the attachment traverses rough terrain or terrain having a steep or changing grade and the wheels lose contact with the ground.

### SUMMARY

An embodiment of the present invention discloses a sub-trailer having an attachment frame that can be removably and pivotally connected to a vehicle or trailer about a vertical axis, an intermediate frame extending rearward of the attachment frame, and a subframe with first and second axles connected to the subframe to support the subframe for travel upon an underlying support surface. The subframe is pivotally connected to the intermediate frame about a horizontal axis that is located between the first and second axles to provide load distribution from the vehicle or trailer to the first and second axles.

Another embodiment of the present invention discloses a sub-trailer having an attachment frame that can be removably connected to a vehicle or a trailer, an intermediate frame extending rearward of the attachment frame and pivotally connected to the attachment frame about a first horizontal axis, and a subframe with first and second axles connected to the subframe to support the subframe for travel upon an underlying support surface. The subframe is pivotally connected to the intermediate frame about a second horizontal axis. The second horizontal axis is spaced apart from the first horizontal axis and located between the first and second axles to provide load distribution from the vehicle or trailer to the first and second axles.

Yet another embodiment discloses a sub-trailer having a frame extending rearwards and being one of a vehicle, a trailer, or an attachment thereof; and a subframe with first and second axles connected to the subframe for rotation relative thereto to support the subframe for travel upon an underlying support surface. The subframe is pivotally connected to the frame about a horizontal axis located between the first and second axles to provide load distribution from the vehicle or trailer to the first and second axles. A first suspension system extends between the subframe and the first axle, and has a pair of trailing arms, a pair of shock absorbers, and a pair of airbags. A second suspension system extends between the subframe and the second axle, the second suspension having a second pair of trailing arms, a second pair of shock absorbers, and a second pair of airbags.

### BRIEF DESCRIPTION OF THE DRAWINGS

FIG. 1 is a perspective view of one embodiment of a sub-trailer illustrated connected to a vehicle and trailer;

FIG. 2 is a side view of the sub-trailer of FIG. 1;

FIG. 3 is a top plan view of another embodiment of a sub-trailer illustrating a portion of an intermediate frame and a subframe;

FIG. 4 is a side elevation view of the sub-trailer of FIG. 3; and

FIG. 5 is a perspective view of the sub-trailer of FIG. 1 illustrated descending from flat terrain to a downhill grade.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

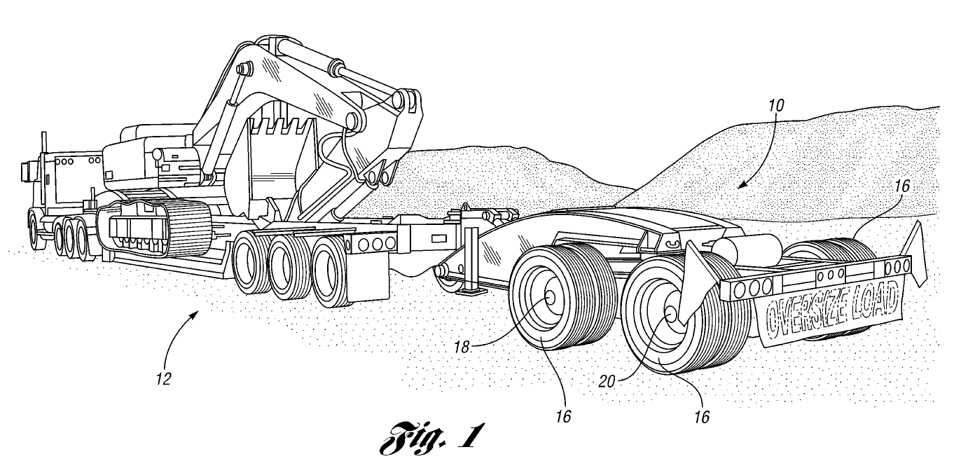

Now referring to FIG. 1, a sub-trailer 10 is illustrated and is connected to a vehicle 12. The vehicle 12 could be a truck, a trailer for a truck, or another piece of heavy equipment according to the invention. The sub-trailer 10 allows for distribution of a load placed on the truck 12 to the wheels 16 connected to the axles of the sub-trailer 10. The sub-trailer 10 is depicted with two axles, a front axle 18 and a rear axle 20, but additional axles are possible. The sub-trailer 10 is designed such that it is capable of being driven over terrain with potentially steep and extreme grades while keeping the wheels 16, which are connected to the axles 18, 20, in contact with the ground. The sub-trailer 10 can distribute a load from the truck 12 to both the front axle 18 and rear axle 20 of the sub-trailer 10, and in one embodiment evenly distributes the load between the axles 18, 20.

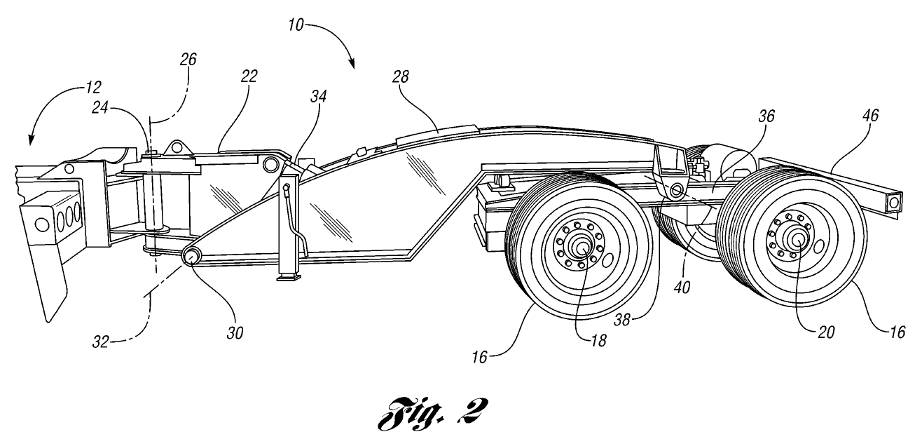

FIG. 2 shows a side view of the sub-trailer 10 connected to the vehicle 12. In one embodiment the sub-trailer 10 has three primary frame components. The first frame component is an attachment frame 22 that can be connected and disconnected from the back of the vehicle 12. The attachment frame 22 is attached to the vehicle 12 using a pivotal connection 24 with a vertical axis of rotation 26, such that the sub-trailer 10 can follow the truck 12 through a turn. The pivotal connection 24 can be a fifth wheel coupling, pintle and gudgeon, or other similar device that allow for the sub-trailer 10 to be removably connected to the vehicle 12 and have rotation about a vertical axis 26.

The second frame component shown in FIG. 2 is an intermediate frame 28. The intermediate frame 28 is connected to the attachment frame 22 via a pivotal connection 30, which allows for motion about a horizontal axis of rotation 32. The intermediate frame 28 is also connected to the attachment frame 22 by a hydraulic loading system 34. The hydraulic loading system 34 is controllable such that it can exert a force on the intermediate frame 28 under specified conditions. The force exerted by the hydraulic loading system 34 on the intermediate frame 28 will cause it to rotate either away or towards the attachment frame 22 about the horizontal axis 32. The hydraulic loading system 34 may be a self-contained unit and an example of one that could be used in this application is an oil over nitrogen accumulator system. When engaged, the hydraulic loading system 34 can lift the wheels 16 of the sub-trailer 10 from contact with the ground or other underlying surface. This may allow for better maneuverability of the truck 12 and sub-trailer 10 assembly while reversing, undergoing difficult turns, or the like.

The third frame component shown in FIG. 2 is a subframe 36, which is connected to the intermediate frame 28 by another pivotal connection 38. This pivotal connection 38 allows for motion about a horizontal axis of rotation 40 located at a different location than the previously described horizontal axis of rotation 32. The intermediate frame 28 arches and extends rearward over the forward portion of the subframe 36 to the attachment point on an upper surface and in a central region of the subframe 36. The axles 18, 20 connect to the subframe 36 at two locations, both of which are lower than the subframe pivotal connection 38. The front axle 18 connects to the subframe 36 at a position forward of the pivotal connection 38. The rear axle 20 connects to the subframe 36 at a location behind the pivotal connection 38. The wheels 16 are attached to the ends of the axles 18, 20 and are in contact with the ground as the sub-trailer 10 is towed by the truck 12. Each wheel 16 can be a single wheel, a tandem wheelset, or a combination of the two, if needed. There can also be a transverse connector bar 46 connected to a rear surface of the subframe 36 in one embodiment. Attached to the rear transverse connector bar 46 may be a taillight assembly 48, or the taillight assembly could be directly attached to a rear surface of the subframe 36. The lights of the taillight assembly 48 are used to indicate braking, turning, and/or hazards.

As the sub-trailer 10 moves in relation to the ground, the two horizontal axes of rotation 32, 40 allow for the wheels 16 to stay in contact with the ground. This can lead to a better and more equal distribution of the load carried by the truck 12 to the front and rear axles 18, 20, through the wheels 16 and to the ground. The sub-trailer 10 can distribute the load while it is being towed over uneven ground or a graded terrain such as uphill or downhill. For example, pivotal motion about the two horizontal axes 32, 40, can evenly distribute a load to the axles 18, 20 while the vehicle 12 and sub-trailer 10 are on different grades, such as the vehicle on a even surface and the sub-trailer on a hill, the vehicle on a hill and the sub-trailer on a flat surface, the vehicle and the sub-trailer on different percentage graded hills, or any other combination.

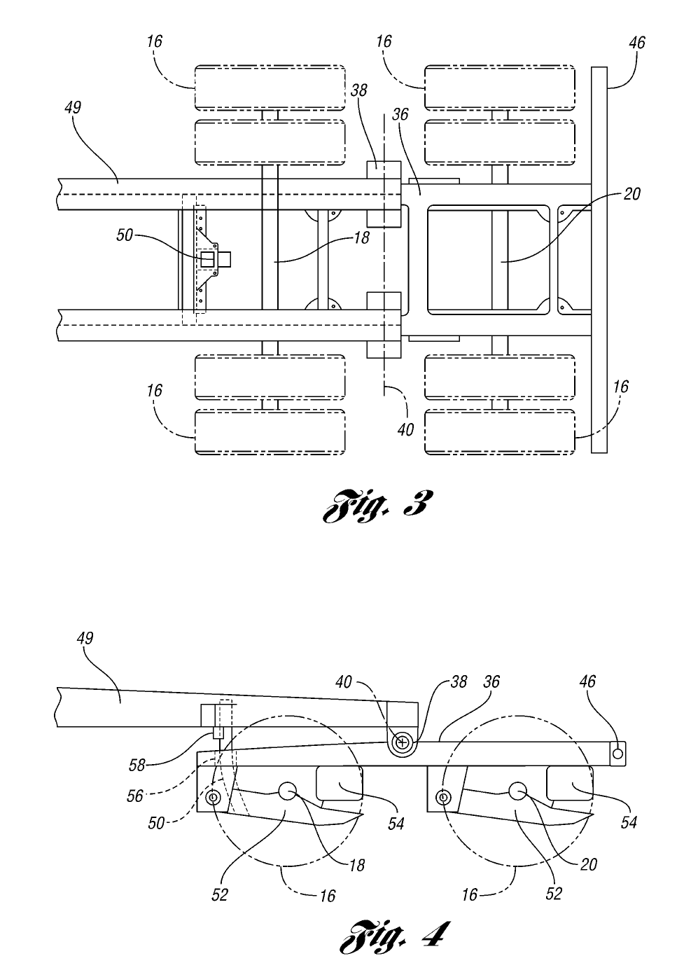

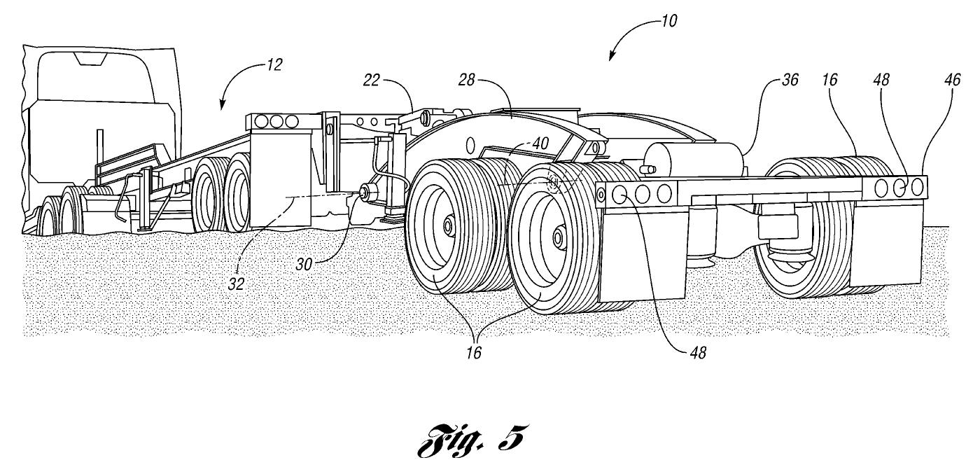

FIGS. 3 and 4 are views of another embodiment of a sub-trailer 10; in these figures, like elements to previous embodiments retain the same reference numerals and new elements are assigned new reference numerals. FIGS. 3 and 4 illustrate a subframe 36 and a portion of an intermediate frame 49. The intermediate frame 49 may be the same as the intermediate frame 28 or it can extend directly from a portion of a trailer or vehicle 12 structure. The intermediate frame 49 extends rearward to a pivotal connection 38 where it attaches to the subframe 36 at an intermediate portion of the subframe 36 and has a horizontal axis of rotation 40. The subframe 36 extends both forward and rearward from the pivotal connection 38. Attached to the subframe 36 is a front axle 18 and a rear axle 20 with a pair of tandem wheel sets 16 attached to each axle. At the rearward portion of the subframe 36, a rear transverse connector bar 46 is attached. This connector bar 46 may have a tail light assembly 48 attached to it, which can indicate braking, turn, and/or emergency signals. The transverse connector bar 46 also provides a mounting point for a license plate or mud flaps.

FIGS. 3 and 4 also show a top view of a bar 50 which extends from the intermediate frame 49 in a downward direction and is engaged to slide with respect to the subframe 36. The sliding bar 50 interacts with and extends through a slot 56 in the subframe 36. The sliding bar 50 acts to prevent a twisting motion of the subframe 36 relative to the intermediate frame 49 and the sliding motion allows for the subframe 36 to move mainly in one vertical plane of motion in relation to the intermediate frame 49 as the subframe pivots on its connection 38 with respect to the intermediate frame 49. A pair of bumpers 58 are used to prevent direct contact of the subframe 36 with the intermediate frame 49. In one embodiment the bumpers 58 are attached to the intermediate frame 49, and alternatively could be attached to the subframe 36. The bumpers 58 can be made from rubber, a plastic, or other type of resilient material, and also may be replaceable with use and wear.

FIGS. 3 and 4 also show an embodiment of a suspension system that may be used. In this suspension system, the front axle 18 is attached to the forward portion of the subframe 36 by first and second trailing arms 52, one each side of the subframe 36. Each trailing arm 52 is pivotally connected to the subframe 36 and interacts with the end of the axle 18, allowing it to move with respect to the subframe 36. Each trailing arm 52 also interacts with a respective vibrational absorption system 54, which in one embodiment may be a combination of an airbag and a shock absorber. The rear axle 20 is also attached to the subframe by a suspension system. In the rear axle 20 suspension system, third and fourth trailing arms 52 are pivotally connected to each side of the rearward portion of the subframe 36 and interact with the ends of the rear axle 20 allowing it to move with respect to the subframe 36. Each of these rear trailing arms 52 interact with a respective vibrational absorption system 54 between the trailing arm and the subframe which in one embodiment may be an airbag system and shock absorber. The four trailing arms 52 interact with the outboard ends of both axles 18, 20 to allow the axle to rotate. The four trailing arms 52 can independently move to react to the ground surface, and act as an independent suspension system. This allows for better load distribution and ride quality as the sub-trailer is on the road or going over rougher terrain.

FIG. 5 shows a perspective view of the sub-trailer 10 on graded terrain as the vehicle 12 descends from flat terrain onto a downhill grade while towing a sub-trailer 10. As can be seen in the figure, all of the wheels 16 remain in contact with the ground or other underlying surface while the vehicle 12 and its sub-trailer 10 are on differently graded terrain. In FIG. 5, all of the wheels 16 of the sub-trailer 10 remain in contact with the ground, which is due in large part to the two horizontal axes 32, 40. The first horizontal axis 32 is located at the pivotal connection 24 of the attachment frame 22 to the intermediate frame 28. The second horizontal axis 40 is located at the pivotal connection 38 of the intermediate frame 28 to the subframe 36. These two pivotal connections 30, 38 are spaced apart and allow for the intermediate frame 28 and the subframe 36 to independently pivot with respect to the attachment frame 22 which is either directly attached to the vehicle 12 or a portion of the vehicle 12 itself. This figure also illustrates the taillight assembly 48 that may be connected to the rear transverse connector bar 46.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A sub-trailer for attachment to one of a vehicle and a trailer, the sub-trailer comprising:
an attachment frame adapted to be removably and pivotally connected to one of a vehicle and a trailer about a vertical axis;
an intermediate frame extending rearward of the attachment frame; and
a subframe having first and second axles, each connected to the subframe for rotation relative thereto for supporting the subframe for travel upon an underlying support surface, the subframe being pivotally connected to the intermediate frame about a first horizontal axis that is located between the first and second axles to provide load distribution from the vehicle or trailer to the first and second axles.

2. The sub-trailer of claim 1 wherein the intermediate frame is pivotally connected to the attachment frame about a second horizontal axis, the second horizontal axis being spaced apart from and forward of the first horizontal axis.

3. The sub-trailer of claim 1 further comprising a hydraulic loading system extending between the attachment frame and the intermediate frame.

4. The sub-trailer of claim 3 wherein the hydraulic loading system is pivotally connected at a first end to the attachment frame rearward of the vertical axis, and pivotally connected at a second end to the intermediate frame forward of the first horizontal axis.

5. The sub-trailer of claim 4 wherein the hydraulic loading system is operable to disengage the sub-trailer from an underlying support surface to assist in maneuvering one of the vehicle and the trailer.

6. The sub-trailer of claim 1 further comprising a first suspension system extending between the subframe and the first axle.

7. The sub-trailer of claim 6 wherein the first suspension system further comprises a first and a second trailing arm, the first and second trailing arms respectively pivotally connecting a first and second distal portion of the first axle to the subframe, and each trailing arm having a vibrational absorption system, the pivotal connections of the trailing arms to the subframe being lower than the first horizontal axis.

8. The sub-trailer of claim 7 wherein the vibrational absorption system further comprises an airbag system and a shock absorber.

9. The sub-trailer of claim 7 further comprising a second suspension system extending between the subframe and the second axle.

10. The sub-trailer of claim 9 wherein the second suspension system further comprises a third and a fourth trailing arm, the third and fourth trailing arms respectively pivotally connecting a first and second distal portion of the second axle to an outer rearward portion of the subframe, and each trailing arm having a vibrational absorption system, the pivotal connections of the trailing arms to the subframe being lower than the first horizontal axis.

11. The sub-trailer of claim 10 wherein the vibrational absorption system further comprises an airbag system and a shock absorber.

12. The sub-trailer of claim 1 wherein the pivotal connection on the subframe is located equidistant from the first and second axles.

13. The sub-trailer of claim 1 further comprising a plurality of tandem wheel sets, each tandem wheel set being attached to one of the distal ends of the front and rear axles.

14. The sub-trailer of claim 1 further comprising a transverse connector bar extending from the rearward portion of the subframe, the transverse connector bar being provided with a mounting point for a taillight assembly.

15. The sub-trailer of claim 1 further comprising:
a pair of bumpers extending between the intermediate frame and a forward portion of the subframe for preventing contact of the intermediate frame and the subframe; and
a bar extending from the intermediate frame, the bar being slidingly engaged with the forward portion of the subframe for prevention of a twisting motion of the subframe relative to the intermediate frame.

16. A sub-trailer for attachment to one of a vehicle and a trailer, the sub-trailer comprising:
an attachment frame adapted to be removably connected to a vehicle or a trailer;
an intermediate frame extending rearward of the attachment frame, the intermediate frame being pivotally connected to the attachment frame about a first horizontal axis; and
a subframe having first and second axles, each connected to the subframe for rotation relative thereto for supporting the subframe for travel upon an underlying support surface, the subframe being pivotally connected to the intermediate frame about a second horizontal axis, the second horizontal axis being spaced apart from the first horizontal axis and located between the first and second axles to provide load distribution from the vehicle or trailer to the first and second axles.

17. The sub-trailer of claim 16 wherein the attachment frame is pivotally connected to one of the vehicle and the trailer about a vertical axis.

18. The sub-trailer of claim 16 further comprising a hydraulic loading system extending between the attachment frame and the intermediate frame.

19. A sub-trailer for attachment to one of a vehicle and a trailer, the sub-trailer comprising:
a frame extending rearwards and being one of a vehicle, a trailer, and an attachment thereof;
a subframe having first and second axles, each connected to the subframe for rotation relative thereto for supporting the subframe for travel upon an underlying support surface, the subframe being pivotally connected to the frame about a horizontal axis located between the first and second axles to provide load distribution from the vehicle or trailer to the first and second axles
a first suspension system extending between the subframe and the first axle, the first suspension having a first pair of trailing arms, a first pair of shock absorbers, and a first pair of airbags; and
a second suspension system extending between the subframe and the second axle, the second suspension having a second pair of trailing arms, a second pair of shock absorbers, and a second pair of airbags.

20. The sub-trailer of claim 19 further comprising:
a bar extending from the frame to slidingly engage with a forward portion of the subframe for the prevention of a twisting motion of the subframe relative to the intermediate frame; and
a pair of bumpers extending from the frame for the prevention of direct contact between the frame and the subframe.
